(19) United States
(12) Patent Application Publication
(10) Pub. No.: US 2006/0262793 A1
(43) Pub. Date: Nov. 23, 2006

(54) Method and system for handover between service delivery platforms by following content

(75) Inventors: Jani Vare, Kaarina (FI); Kari S. Virtanen, Merimasku (FI); Harri Pendolin, Helsinki (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/132,297

(22) Filed: May 19, 2005

(51) Int. Cl. H04L 12/56; H04L 12/28

(52) U.S. Cl. 370/390; 370/392

(57) ABSTRACT

Systems and methods are provided for identifying the content aggregator and the content of a service in a digital broadband broadcast system. A media identifier, which includes a content aggregator identifier and a content identifier, is inserted in an IPv6 address field. Consumers of broadcast content are able to transition between service providers offering the same combination of content and content aggregator. Mobile terminals select a handover candidate based on the number of currently consumed services offered and on the signal quality of the candidate.

### FIELD OF THE INVENTION

The invention relates to handovers in a digital broadband broadcast network. More particularly, the invention provides for handovers between service systems which allow continuous delivery of the same content.

### BACKGROUND OF THE INVENTION

Digital broadband broadcast networks enable end users to receive digital content as they move from location to location. Digital content may include video, audio, data, and so forth. Using a mobile terminal, a user may receive digital content over a wireless digital broadcast network. The digital broadcast signal may include service information which may provide the mobile terminal with information about available digital content, as well as information about the network and other nearby networks. The mobile terminal may then display a list or menu of available digital content. A user may then select a program or programs to watch, listen to, or otherwise consume.

As a user travels between networks, a mobile terminal may need to perform a handover in order to receive a new broadcast signal as the old one fades. Similarly, a mobile terminal may need to change networks after being temporarily powered down, for example when arriving at a flight destination. A mobile terminal may be able to select a new network from among multiple overlapping networks when having to perform such a handover. The user of the mobile terminal may wish to continue viewing or listening to the same content without having to re-select the same digital content from the new network's menu. When the same or similar digital content (e.g., the Summer Olympics) is broadcast via different service platforms and different networks, however, there is presently no way to select a handover network that assures reception of the same content.

Therefore, there is a need in the art for systems and methods which allow a user of a mobile terminal to receive the same or similar digital broadband broadcast content when handing over from one network to another.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

A first embodiment of the invention provides a method for identifying digital content in a digital broadband broadcast system. A media identifier is assigned to digital content, the identifier being a combination of an identifier of a content aggregator and an identifier of the content itself. The media identifier is then inserted into a network packet address associated with the digital content.

A second embodiment of the invention provides a method for performing a handover between digital broadband broadcast networks. Media identifiers for currently consumed services are sought among the offerings of handover candidates. Based on the number of media identifiers found, coupled with signal quality measurements, a handover candidate is selected and a handover is performed.

### BRIEF DESCRIPTION OF THE DRAWINGS

The present invention is illustrated, by way of example and not limitation, in the accompanying figures in which like reference numerals indicate the same or similar elements and in which:

FIG. 1 illustrates a suitable digital broadband broadcast system in which one or more illustrative embodiments of the invention may be implemented;

FIG. 2 illustrates a digital broadband broadcast system according to one or more illustrative embodiments of the invention;

FIG. 3 illustrates the mapping of a media identifier into an IPv6 address according to one or more illustrative embodiments of the invention;

FIG. 4 illustrates the use of a media identifier when selecting a network for handover according to one or more illustrative embodiments of the invention;

FIG. 5 is a flowchart of a method for performing a handover using media identifiers according to one or more illustrative embodiments of the invention; and

FIG. 6 illustrates a functional block diagram of a suitable mobile terminal in which one or more illustrative embodiments of the invention may be implemented.

### DETAILED DESCRIPTION OF THE DRAWINGS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

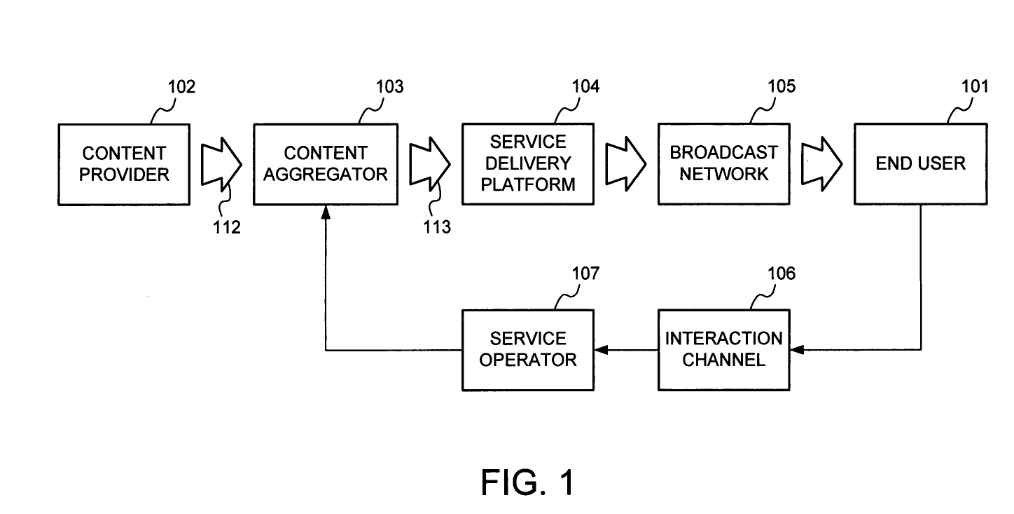

FIG. 1 illustrates a suitable digital broadband broadcast system in which one or more illustrative embodiments of the invention may be implemented. The blocks represent functional portions of the digital broadband broadcast system and need not be carried out separately. For example, the functions of content provider 102 and content aggregator 103 may be provided by a single entity or within the same subsystem. Systems such as the one illustrated here may be utilized by a digital broadband broadcast technology, for example Digital Video Broadcast-Handheld (DVB-H). Examples of other digital broadcast standards which may utilize the invention include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Digital Audio Broadcasting (DAB), and Digital Radio Mondiale (DRM). Other digital broadcasting standards and techniques, now known or later developed, may also be used.

The system illustrated in FIG. 1 may be utilized to provide Internet Protocol (IP) Datacasting to end user 101. In an IP Datacasting (IPDC) system, digital content is delivered to an end user in the form of network packets. The system may also be utilized to provide other forms of digital broadcasting, such as may be used by those technology standards listed above. IPDC network packets may comprise IPv4 or IPv6 packets.

Digital content 112 may be created and/or provided by content provider 102 and may include video signals, audio signals, data, and so forth. For example, content provider 102 may be providing a video signal of an international sporting event. Content 112 may also include an accompanying audio signal. Content 112 may further include data such as updated scores of the event. Content provider 102 may then deliver content 112 to content aggregator 103, who may provide content 112 in the form of a service 113 to service delivery platform 104 for eventual delivery to end user 101. Service delivery platform 104 may comprise software installed on a server, wherein the server comprises a processor and associated memory. Other implementations of service delivery platform 104 may be available.

Service delivery platform 104 may utilize IP datacasting for delivering services 113 to end user 101. Service delivery platform 104 may form service 113 into network packets such as IPv6 packets. Using DVB-H as an example, service 113 may be formed into IP network packets such as IPv6 packets. The network packets are then bundled into transport streams (e.g., MPEG-TS streams), along with metadata about offered services and their delivery. Metadata incorporated with content in a DVB system may comprise a series of standardized data tables including, for example, one or more IP/MAC Notification Tables (INT). Exemplary standards for metadata (also known as service information) used in digital video broadcasting and data broadcasting are found, among other places, in two European Telecommunications Standards Institute documents: “Digital Video Broadcasting (DVB): Specification for Service Information (SI) in DVB Systems,” ETSI EN 300 468 (latest version 1.6.1), and “Digital Video Broadcasting (DVB): DVB Specification for Data Broadcasting,” ETSI EN 301 192 (latest version 1.4.1).

Broadcast network 105 distributes the transport streams provided by system delivery platform 104 to end user 101, where the network packets can be unbundled and utilized. End user 101 may utilize some form of interaction channel 106 in order to communicate with service operator 107. This interaction channel may include a cellular network, or some other system for relaying messages from end user 101 to service operator 107. Messages may be sent via a two-way audio connection (e.g., phone call), via short message service (SMS), via multimedia message service (MMS), via a web browser, or via some other communication scheme. By communicating with service operator 107, end user 101 may be enabled to view restricted or for-pay content. Service operator 107 may enable this authorization by communicating with content aggregator 103.

IP addresses utilized by a particular service delivery platform 104 need only be unique for that service delivery platform. This means that the same IP address may be used by separate service delivery platforms without causing a conflict. As such, service delivery platform 104 may be viewed as a private IP network, where any possible IP address may be assigned to network packets.

Services provided by service delivery platform 104 may be provided by content aggregator 103 or directly by content provider 102. Services may additionally be provided to service delivery platform 104 by other content aggregators and other content providers. All of the services available to end user 101 from service delivery platform 104 may be announced by their IP addresses delivered via IP/MAC Notification Tables (INTs), or via other forms of metadata.

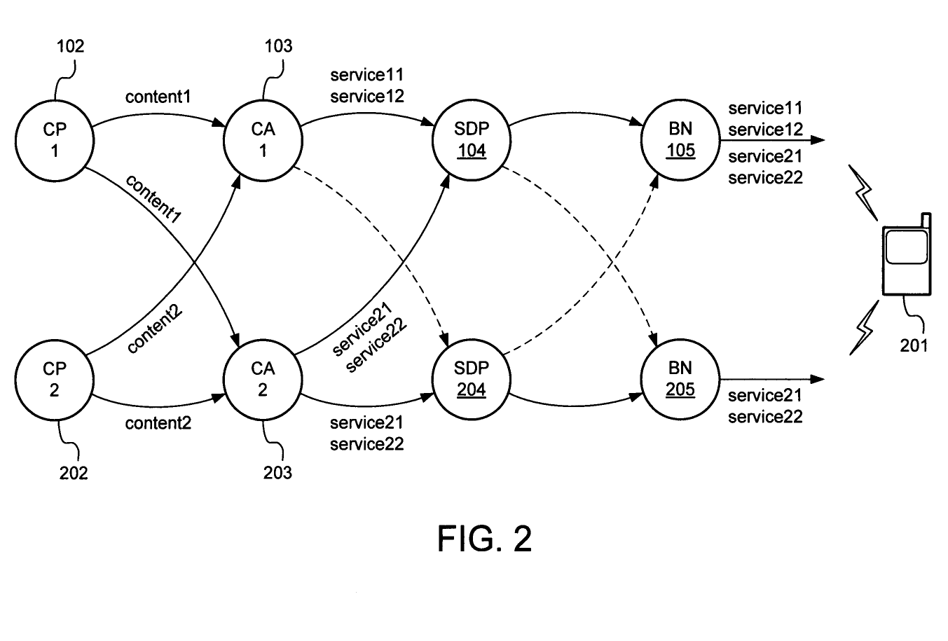

FIG. 2 illustrates a more complex digital broadband broadcast system according to one or more illustrative embodiments of the invention. Here, some of the elements of FIG. 1 are coupled with similar components providing additional content and services. End user 101 is a mobile terminal 201, receiving signals from multiple transmitters. Mobile terminals may include a variety of electronic devices, including cellular phones, mobile digital video broadcast (DVB) receivers, pagers, personal digital assistants, laptop computers, automobile computers, portable video players, and other devices which may move among multiple cells and which include equipment for receiving signals from a wireless network. In addition to DVB receivers, mobile terminals may include mobile receivers of other digital broadband broadcast systems, such as those listed above.

Similar to FIG. 1, content provider 102 delivers content1 (e.g., Summer Olympics) to content aggregator 103 (e.g., a family of networks such as BBC). In addition, content provider 102 also provides content1 to content aggregator 203 (e.g., a network such as CNN). Content provider 202 delivers content2 (e.g., a news documentary) to both content aggregators 103 and 203.

Content aggregator 103 provides the two contents as services to service delivery platform 104. Here, the services have been labeled service11 and servicel2. The combined digits in the label may be considered a media identifier, or media_id. The first digit “1” serves as an identifier of the content aggregator, and the second digit “1” or “2” serves as an identifier of the content. Hence, service11 is a service of the content aggregator identified as “1” and the content identified as “1.” Servicel2 is also a service provided by content aggregator “1”, but with content identified as “2.” The combination of identifiers for the content aggregator and the content creates a uniquely identified service. Similarly identified service21 and service22 are delivered by content aggregator 203 to both service delivery platforms 104 and 204. Service delivery platform 104 delivers all four provided services to broadcast network 105, which then transmits the services via radio frequency. Similarly, service delivery platform 204 delivers two provided services to broadcast network 205, which transmits the services via radio frequency.

Mobile terminal 201 may move from the coverage area (not shown) of broadcast network 105 into the coverage area (not shown) of broadcast network 205. In so doing, a handover may be performed, wherein mobile terminal 201 stops receiving signals from broadcast network 105 and starts receiving signals from broadcast network 205. Mobile terminal 101, by searching for a particular media identifier or media_id among the services available from broadcast network 205 and service delivery platform 204, is able to maintain reception of the same or similar content he was previously receiving, even though the network and service delivery platform have changed. For example, if mobile terminal 101 was previously receiving service21 (e.g., the Summer Olympics), the terminal is able to find that same or similar service in the new broadcast network by seeking the particular media identifier.

Once the same or similar service is found or discovered in the new network, the user may not be able to access it if is encrypted or otherwise unavailable. If a user of mobile terminal 201 has previously paid for a subscription to the content through a particular content aggregator, utilizing media identifiers may enable continuous coverage with or without new charges being incurred. A media identifier may also allow content to be recognized between service delivery platforms, even when the name and/or network address of the content changes.

A media identifier provides a consistent way for identifying services across service delivery platforms and across broadcast networks. By identifying both the content aggregator providing the service and the content of the service, the service will be globally identifiable. Although media_id or media identifier is used as a single term, it embodies two identifiers, a content identifier and a content aggregator identifier. Embodiments are possible wherein the media_id is split into separate values and delivered separately. The content_aggregator_id need not necessarily precede or follow the content_id.

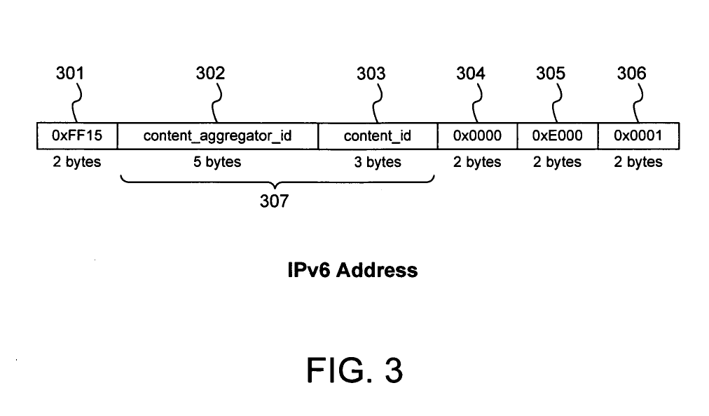

FIG. 3 depicts one method for labeling a service with a particular media identifier. The figure depicts the mapping of a media identifier into an IPv6 address according to one or more illustrative embodiments of the invention. The IPv6 address may be incorporated into the header of an IPv6 packet, and may also be listed in service information (SI) metadata, such as in an INT table. By incorporating the media_id into the IPv6 address, no service information (SI) standards need be adjusted and no additional bytes or bandwidth are needed than would have already been used. Because service delivery platforms, which assign multicast IPv6 addresses, have flexibility in addressing within their virtually private networks, they may incorporate media identifiers into the addresses they generate. Although one particular method of inserting a media identifier into a network packet is provided, other locations for the identifier will be understood to be within the scope of this invention by those skilled in the art. Other varieties of network packets may have their headers and/or addresses manipulated so as to include a media identifier. For example, IPv4 addresses may be so modified, although with fewer available content_ids and content_aggregator_ids, given the 4 byte length of an IPv4 address.

Here, a 16-byte IPv6 address is broken down into sections of bytes. Byte section 301 of the address may constitute a 2-byte multicast address identifier, including multicast flags and scope. Byte section 302 may represent a 5-byte content_aggregator_id. This may be assigned based on the identity of the content aggregator providing the particular service being labeled. These identifiers should be globally unique so that different content aggregators don't use the same identifier and cause conflicts. They may be assigned singly or in ranges to content aggregators by a third party responsible for registration. Byte section 303 may represent a 3-byte content_id. This may be assigned by a content provider to uniquely identify the underlying content. As with content_aggregator_ids, content_ids may be assigned in ranges to content providers by a third party in order to prevent id conflicts. Content_ids are unique in that they can be reused by a particular content provider at a later time while maintaining identity in the present. Remaining byte sections 304, 305, and 306 may be assigned by the service delivery platform. Byte section 304 in particular may be unused and remain NULL.

The combination of content_aggregator_id and content_id byte sections 302, 303 create a media identifier 307 or media_id which uniquely identifies the service to which they are being applied. Different service delivery platforms receiving the same or similar content from the same content aggregator will consistently assign the services an IPv6 multicast addresses with the same media identifier 307. The remainder of the IPv6 addresses will likely vary by platform. By searching for a media identifier, a mobile terminal in receipt of network packets addressed in this fashion may be able to locate the same or similar service across multiple networks and multiple service delivery platforms.

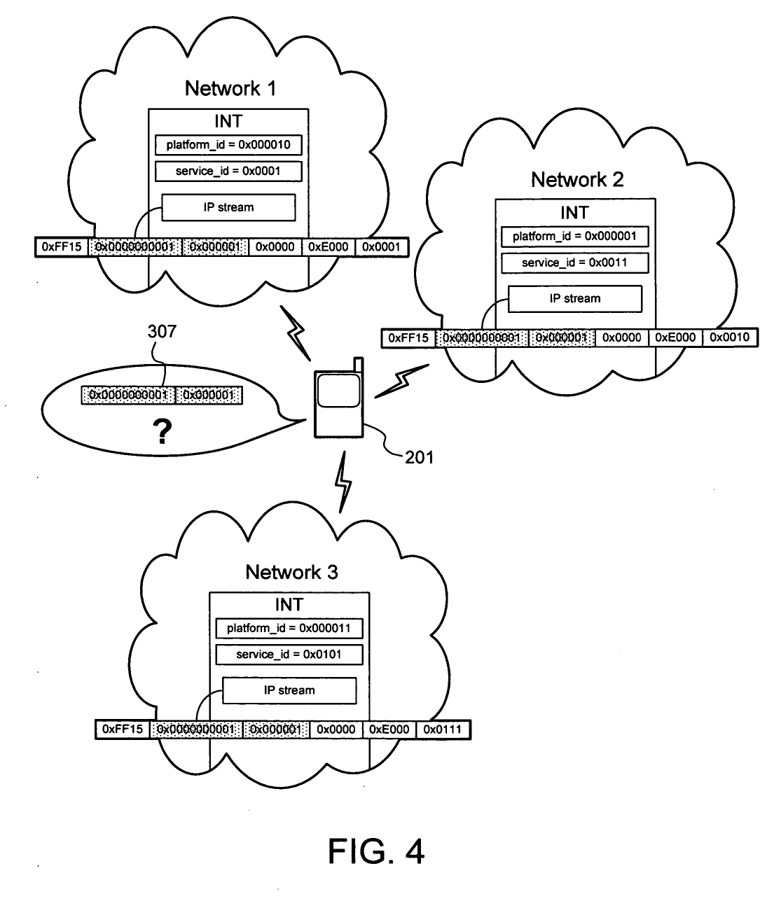

FIG. 4 illustrates the use of a media identifier when selecting a network for handover according to one or more illustrative embodiments of the invention. Here, mobile terminal 201 is preparing to leave a particular broadcast network coverage area (not shown). Among the candidate networks for handover (networks which may be overlapping) are Networks 1, 2, and 3. Each network broadcasts one or more IP/MAC Notification Tables (INTs), which are received and interpreted by mobile terminal 201. Each network may be broadcasting services from different service delivery platforms, identified by the differing platform_ids displayed in the INT tables of each network. Within each INT table, the IP addresses of services available on that network are announced. INT tables are typically broadcast at regular intervals by each of the broadcast networks.

Mobile terminal 201 is presently receiving a service (e.g., the Summer Olympics) from the departing network. The service has media_id 307, where the content_aggregator_id is number 1, and the content_id is number 1. As mobile terminal 201 receives the INT tables from each of the candidate networks, it compares the media_id portion of the IP addresses provided to see if same service is offered. Mobile terminal 201 may then use this information as a factor in deciding to which network a handover will be performed. If mobile terminal 201 is receiving multiple services at the time of handover, then it may search for multiple media_ids on each of the candidate networks. The handover candidate with the most services in common with the departing network may be selected, although other factors such as signal quality may be controlling. By handing over to the network with the most services in common, mobile terminal 201 may not need to interrupt services, making the transition seamless for the end user. Returning to FIG. 4, based on the announced media_ids, all three candidate networks offer the service for which mobile terminal 201 is seeking. This may mean that a seamless transition to any of the networks should be possible, and other factors such as measured signal quality may come into play in deciding among the candidates.

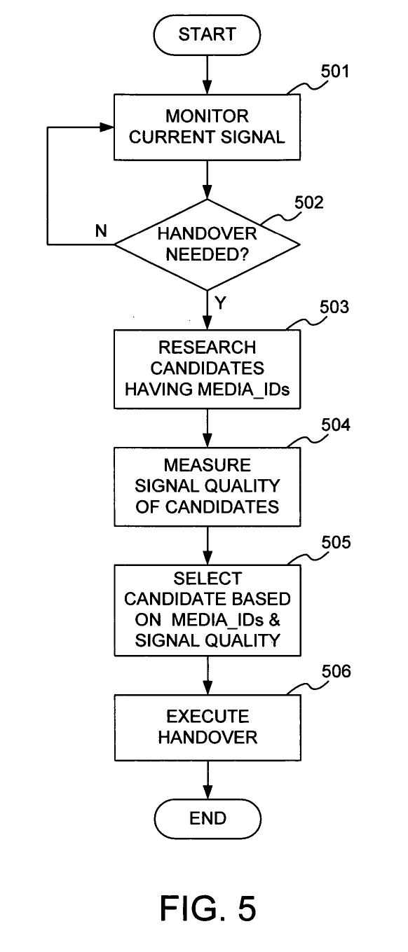

FIG. 5 is a flowchart of a method for performing a handover using media identifiers according to one or more illustrative embodiments of the invention. Such a method may be used by a device, such as mobile terminal 201. Those skilled in the art will understand that the steps presented in FIG. 5 are merely representative, and that steps may be added, combined, or removed. At step 501, a device is currently receiving a digital broadcast signal and consuming a service or services offered via that signal. While consuming these services, the device regularly checks to see if a handover is needed. The decision 502 may be based on monitoring the quality of the signal received, where a decrease in signal quality may alert the device to a need for a handover. The decision may also be based on knowledge of the device's location within a cell. If a handover is not presently needed, then the signal continues to be monitored by the device.

If a handover is needed, at step 503, the services offered by candidate cells and/or networks are researched. This may involve receiving signals from candidate networks and detecting the services offered in INT tables. It may also involve listening to the network traffic. Step 503 may alternatively involve discovering the services offered by nearby networks based on information passed from the current network. Regardless, the media_ids of currently (or frequently) consumed services are sought among the media_ids of the candidates. The number of media_ids in common is tracked for each candidate.

At step 504, the signal quality of the various candidates is measured. This may involve measuring the signal quality once, or several times to develop a rate of change. Regardless of how signal quality is measured, at step 505, the candidate having the best combination of media_ids in common with the current network and the highest signal quality will be selected for handover. Finally at step 506, the handover is executed, and services being consumed by the device seamlessly arrive from the new network.

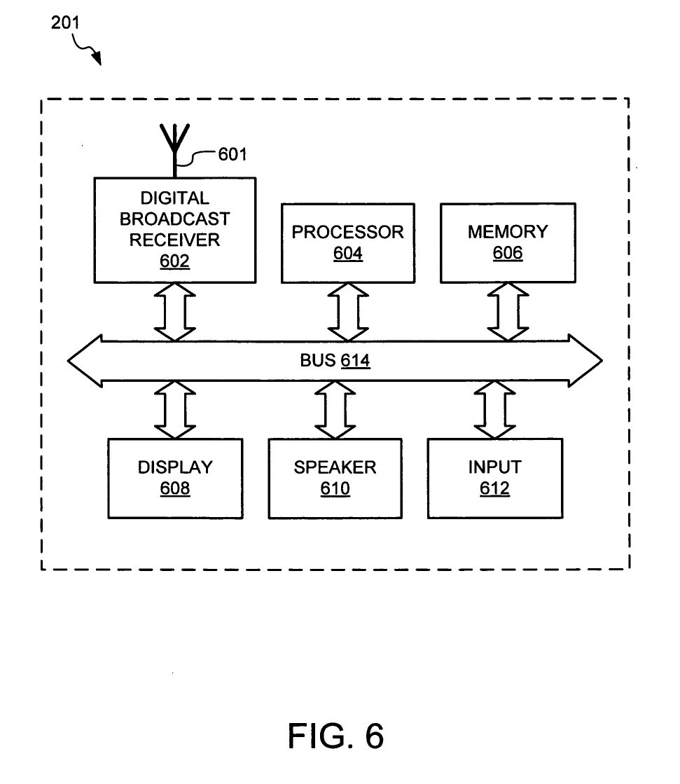

FIG. 6 illustrates a functional block diagram of mobile terminal 201 in which one or more illustrative embodiments of the invention may be implemented. Mobile terminal 201 may include digital broadcast receiver 602, which may include antenna 601. Radio signals transmitted by broadcast network 105 are received via antenna 601 and passed to receiver 602. Receiver 602 may decode consumable digital content from the received signals. Receiver 602 may also include, in various embodiments, a processor (e.g., a microcontroller) and/or memory. Digital content may additionally or alternatively be decoded by processor 604. Processor 604 may also enable digital content to be consumed in the form of video for output via one or more displays 608 or audio for output via speaker and/or earphones 610. Digital content may also be stored in memory 606 for future processing or consumption.

Memory 606 may also store program specific information and/or service information (PSI/SI), including information about digital content available in the future or stored from the past. A user of mobile terminal 201 may view this stored service information on display 608 and select an item of digital content for viewing, listening, or other uses via input 612, which may take the form of a keyboard, keypad, scroll wheel, or other input device(s) or combinations thereof. When digital content is selected, processor 604 may pass information to receiver 602, so that the receiver may act appropriately (e.g., tune a radio or filter signals based on PSI/SI in order to yield specific digital content for the user). Digital content and PSI/SI may be passed among functions within mobile terminal 201 using bus 614.

Various methods, operations, and the like described herein may, in various embodiments, be implemented in hardware and/or in software. Hardware may include one or more integrated circuits. For example, in various embodiments, the methods described may be performed by specialized hardware, and/or otherwise may not be implemented in general purpose processors. One or more chips and/or chipsets may be employed, including one or more application-specific integrated circuits (ASICs).

Mobile terminal 201 may include other functional components (not shown) such as a cellular radio or other RF transceiver. Such functionality may be used for audio transmissions when coupled with a microphone (not shown) and speaker 610, as in a wireless phone, for example. Additional communication components (not shown) may be used to request and/or retrieve authorization to view or listen to protected digital content, enabling the enforcement of digital copyrights and pay-for-use regimes. Mobile terminal 201 may also include functionality to detect a location of the terminal, for example a Global Positioning System (GPS) or an Assisted GPS (AGPS). Although one particular functional diagram for mobile terminal 201 is provided, those skilled in the art understand that functionality may be added or removed, but the invention may still be implemented within the mobile terminal.

While aspects of the invention have been described with respect to specific examples, including presently preferred modes of carrying out the invention, those skilled in the art will appreciate that there are numerous variations and permutations of the above described systems and techniques that fall within the spirit and scope of the invention as set forth in the appended claims.

We claim:

1. A method for identifying digital content, the method comprising:
receiving digital content from a first content aggregator;
assigning a first media identifier to the digital content, wherein the first media identifier comprises an identifier of the first content aggregator and a unique identifier of the digital content;
incorporating the media identifier into a network packet; and
broadcasting the network packet over a wireless network.

2. The method of claim 1, further comprising:
incorporating a multicast identifier into the network packet, wherein the multicast identifier comprises 2 bytes located at the beginning of a network address.

3. The method of claim 1, wherein the network packet is an IPv6 packet.

4. The method of claim 3, wherein incorporating the media identifier into the header field of the IPv6 packet comprises incorporating the media identifier into an IPv6 address field.

5. The method of claim 3, wherein the media identifier constitutes a total of 8 bytes within the IPv6 address field.

6. The method of claim 5, wherein the 8 bytes of the media identifier are contiguously located within the 16-byte IPv6 address field such that the first byte of the media identifier appears in the third byte of the address field.

7. The method of claim 1, wherein the digital content comprises video.

8. The method of claim 1, wherein the network packet is broadcast using digital video broadcasting for handhelds (DVB-H).

9. The method of claim 1, further comprising:
assigning a second media identifier to additional digital content received from a second content aggregator, wherein the second media identifier comprises an identifier of the second content aggregator.

10. A method for performing a handover, comprising:
determining a need for a handover in a wireless network;
determining a media identifier associated with a currently received content, wherein the media identifier comprises an identifier of a content aggregator associated with the currently received content, and wherein the media identifier further comprises a unique identifier of the currently received content;
determining whether one or more handover candidates offer content associated with the media identifier; and
selecting a target handover candidate based on whether the target handover candidate offers content associated with the media identifier.

11. The method of claim 10, further comprising:
selecting a target handover candidate further based on a signal quality of a signal transmitted by the target handover candidate.

12. The method of claim 10, wherein determining whether one or more handover candidates offer content associated with the media identifier comprises searching a network address for the media identifier.

13. The method of claim 12, wherein the network address is an IPv6 address.

14. The method of claim 13, wherein the media identifier constitutes a total of 8 bytes within the IPv6 address.

15. The method of claim 14, wherein the 8 bytes of the media identifier are contiguously located within the 16-byte IPv6 address field such that the first byte of the media identifier appears in the third byte of the address field.

16. The method of claim 10, wherein the currently received content comprises video.

17. The method of claim 10, wherein the wireless network is a digital video broadcasting for handhelds (DVB-H) network.

18. The method of claim 10, further comprising:
determining additional media identifiers associated with a additional currently received content;
determining whether the one or more handover candidates offers content associated with the additional media identifiers; and
selecting a target handover candidate further based on selecting a candidate with the greatest number of media identifiers in common with currently received content.

19. A system for identifying digital content, the system comprising:
a service delivery platform, wherein the service delivery platform comprises:
a processor configured to receive digital content from a source; to assign a media identifier to the digital content, the media identifier comprising an identifier of the source and a unique identifier of the digital content; to incorporate the media identifier into a network packet; and to broadcast the network packet over a wireless network.

20. The system of claim 19, further comprising:
a content aggregator, wherein the content aggregator is configured to receive the digital content from a content provider, and to forward the digital content to the service delivery platform, and wherein the source comprises the content aggregator.

21. The system of claim 19, further comprising:
a broadcast network, wherein the processor is further configured to forward the digital content to the broadcast network for wireless broadcast transmission.

22. The system of claim 19, wherein the header field of a network packet comprises an address field of an IPv6 packet.

23. The system of claim 22, wherein the media identifier constitutes a total of 8 bytes within the IPv6 address field.

24. A mobile terminal, comprising:
a receiver for receiving one or more digital broadband broadcast signals; and
a processor, configured to perform steps of:
searching for one or more media identifiers in one or more network addresses associated with services offered by handover candidates wherein the media identifier comprises an identifier of a content aggregator and a unique identifier of currently received content;
selecting a handover candidate based on one or more found media identifiers; and
performing a handover to the selected candidate.

25. The mobile terminal of claim 24, wherein the processor is further configured to:
measure a signal quality of signals broadcast by handover candidates; and
select a handover candidate further based on the measured signal quality.

26. A mobile terminal, comprising:
a receiver for receiving one or more digital video broadcasting for handheld (DVB-H) signals; and
a processor, configured to perform steps of:
searching for one or more media identifiers in one or more IPv6 addresses associated with services offered by handover candidates wherein each media identifier comprises 8-bytes, including a 5-byte identifier of a content aggregator and a unique 3-byte identifier of currently received content;
selecting a handover candidate based on one or more found media identifiers; and
performing a handover to the selected candidate.
